(19) United States
(12) Patent Application Publication
(10) Pub. No.: US 2011/0127379 A1
(43) Pub. Date: Jun. 2, 2011

(54) Modular Device Holder

(75) Inventors: Hartwig Jäger, Jork (DE); Gerd Rohlfs, Jork (DE); Benjamin Bartels, Hamburg (DE); Olaf Luedemann, Scheessel (DE)

(73) Assignee: AIRBUS OPERATIONS GMBH, Hamburg (DE)

(21) Appl. No.: 12/919,339

(22) PCT Filed: Feb. 12, 2009
(86) PCT No.: PCT/EP2009/051624

§ 371 Date: Nov. 12, 2010

Related U.S. Application Data
(60) Provisional application No. 61/066,969, filed on Feb. 25, 2008.

(30) Foreign Application Priority Data
Feb. 25, 2008 (DE) 10 2008 011 026.4

(51) Int. Cl. B64C 1/22; B60R 11/00

(52) U.S. Cl. 244/118.1; 211/86.01

(57) ABSTRACT

The invention relates to a device holder for mounting devices in a vehicle. Said device holder comprises at least one external rack and at least one internal rack. The at least one external rack can be mounted on the vehicle structure and has a storage space that is designed to introduce and releasably attach the at least one internal rack. The internal rack has means for forming at least one compartment that has a variable size in order to introduce and mount at least one device. The device holder according to the invention can be particularly well adjusted to the devices that are to be integrated into the vehicle, can optimally utilize the available space, and can be equipped with user-specific devices in standard racks.

### REFERENCE TO RELATED APPLICATIONS

This application claims the benefit of the filing date of U.S. Provisional Patent Application No. 61/066,969 filed Feb. 25, 2008, and of German Patent Application No. 10 2008 011 026.4 filed Feb. 25, 2008, the disclosure of which applications is hereby incorporated herein by reference.

### FIELD OF THE INVENTION

The invention pertains to an equipment carrier for mounting equipment in a vehicle.

### TECHNOLOGICAL BACKGROUND OF THE INVENTION

In modern vehicles such as, for example, passenger aircraft, there is an increasing trend to install technical equipment that does not contribute to the actual operability of the vehicle, but rather fulfills other functions. This equipment may consist, for example, of on-board entertainment or communications equipment. Equipment of this type is usually installed into designated equipment carriers that are arranged at special preferred installation points within the vehicle. In passenger aircraft, for example, such installation points may be situated underneath the cockpit, within overhead stowage compartments or at the other suitable locations. With respect to passenger aircraft, the aforementioned equipment, which is also referred to as “commercial equipment,” is for the most part separated locally or at least from the supply of avionics equipment required for the safe operation of the aircraft. A conventional equipment carrier usually consists of a closed housing that is preferably realized in the form of a sandwich structure with metal reinforcements, wherein this housing is fireproof and smokeproof and mounted on the aircraft structure in a suspended or standing fashion with the aid of braces. There furthermore exist equipment carriers with an open design that are realized in a self-supporting fashion. Equipment carriers are also connected, in particular, to the electrical system for supplying the equipment and to a cooling system of the aircraft for dissipating waste heat of the equipment. Customer-specific adaptations can be realized in the interior of the equipment carrier.

### SUMMARY OF THE INVENTION

In existing solutions of equipment carriers for aircraft, it is disadvantageous that existing equipment carriers are only individually developed for certain equipment and equipment, the type of which is predefined by the configuration of the aircraft, but not necessarily suitable for other equipment to be subsequently installed. If new equipment or equipment that initially was not provided needs to be integrated into an existing equipment carrier, this results in, for example, relatively small equipment blocking the available structural space, but simultaneously not fully utilizing the equipment carrier. Consequently, an oversized equipment carrier with a weight higher than necessary is transported along with the aircraft for a long operating time. However, if the equipment carrier is not sufficiently large for the equipment to be subsequently integrated, a new structural space needs to be located within the aircraft and examined in order to develop a suitable equipment carrier for the equipment to be integrated. All things considered, conventional equipment carriers cannot be flexibly utilized for accommodating equipment of different structural shapes and sizes.

It is therefore the object of the invention to propose an equipment carrier that is designed for integrating various types of equipment into the equipment carrier in order to simultaneously reduce the development expenditures and to utilize the structural space available in the aircraft as effectively as possible.

This object is met by an equipment carrier according to claim 1 that features at least one outer rack and at least one inner rack, wherein the outer rack can be supported on the structure of the aircraft and the inner rack can be installed on or in the outer rack and features means for forming one or more compartments of variable size. These means may consist of flat, frame-like, linear or punctiform elements that are installed within the inner rack such that they can displaced in fixed stages or continuously. The inner rack preferably consists of a metal carrier that can be inserted into the outer rack.

The equipment carrier according to the invention may have a modular design and therefore can be easily manufactured from standardized components or assemblies. An outer rack can be arranged or supported within the available volume of the vehicle in order to provide a standardized structural space that can be fully utilized and eliminates the need to examine the structural space and identify connecting points during equipment retrofitting. The inner rack, in which several compartments of various sizes can be provided, supplements the outer rack so as to form a complete equipment carrier. The compartments preferably feature inserts (so-called “trays”) for the equipment to be integrated while the rear wall (“backplane”) of the inner rack features connecting points and interfaces, particularly for the electrical supply and for links to data networks or data buses. The equipment carrier is preferably designed in such a way that the outer rack can completely support the loads of the vehicle and of the equipment carrier. The outer rack is preferably supplied in different standard widths in order to realize various configurations for equipment to be installed and to save as much weight as possible by adapting to the required structural space. The inner rack should be adaptable to the requirements of the equipment to be installed and provide the option of installing the equipment in the interior of the inner rack in accordance with customer requirements. The equipment carrier according to the invention furthermore makes it possible to combine different outer racks with one another in a modular fashion such that new standardized structural space can be easily made available for equipment to be subsequently supplemented and this new structural space can be optimally utilized with the aid of inner racks.

The equipment carrier according to the invention provides several advantages in comparison with equipment carriers according to the state of the art. First of all, the development expenditures for the integration of various equipment are reduced. This means that an equipment carrier is able to flexibly accommodate various equipment to be installed. In addition, the modular design makes it possible to provide standardized interfaces for cooling, for the electrical supply and for the mechanical support of the equipment carrier without requiring extensive prior examinations. It is also relatively easy to subsequently expand an equipment carrier according to the invention such that certain flexibility for additional equipment is provided within the aircraft. No additional examinations are required within the structural space of the vehicle because a standardized structural space is available within the outer rack.

The object is furthermore attained with the utilization of an equipment carrier according to the invention in an aircraft, as well as an aircraft with an equipment carrier according to the invention.

### SHORT DESCRIPTION OF THE DRAWINGS

The invention is described in greater detail below with reference to the figures. In the figures, identical objects are identified by the same reference symbols. In these figures:

FIG. 1 shows a general overview of an equipment carrier according to the invention in the installed state;

FIG. 2 shows an overview of the outer frame rack, the inner frame rack and an assembled equipment carrier according to the invention;

FIG. 3 shows an overview of the expandability of an equipment carrier according to the invention;

FIGS. 4a to 4c show equipment carriers according to the invention in the installed state with different expansion stages, and

FIG. 5 shows an exemplary installation position of an equipment carrier according to the invention.

### DETAILED DESCRIPTION OF EXEMPLARY EMBODIMENTS

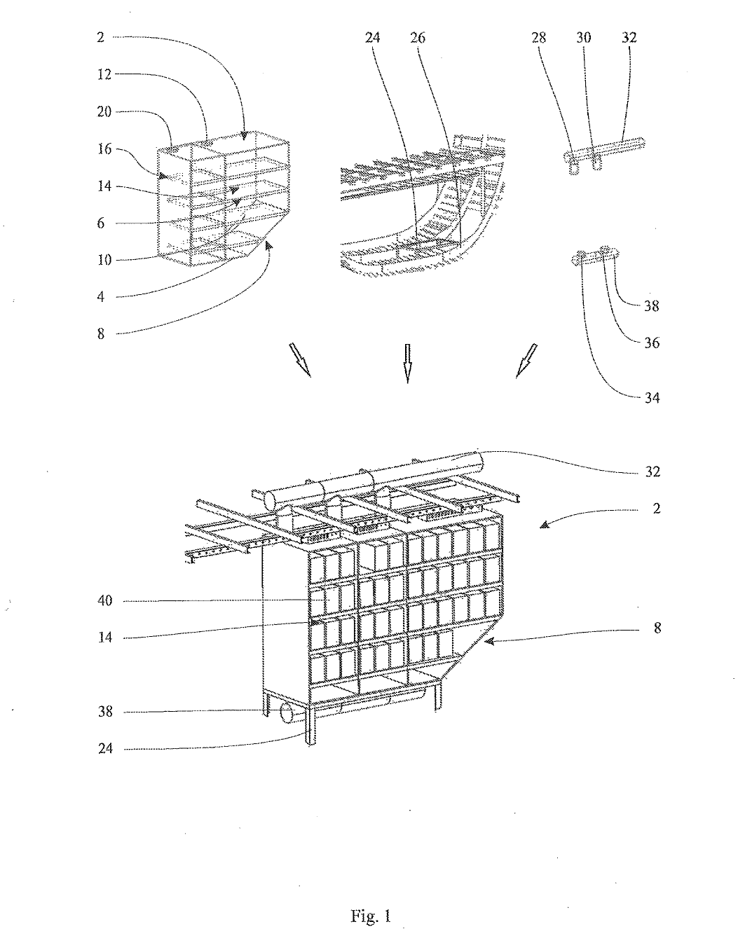

The basic design of an equipment carrier according to the invention is illustrated in FIG. 1. The equipment carrier 2 according to the invention features an outer rack 4, into which an inner rack 6 can be installed. The racks 4 and 6 are illustrated in the form of exemplary frame racks with an at least partially cased frame structure. For example, the outer rack 4 is beveled on a lower corner 8—as illustrated in FIG. 1—such that it can be laterally installed, for example, into the cargo area of an aircraft that features slanted lower wall regions. Consequently, the outer frame rack 4 can optimally utilize the space provided in a cargo area and simultaneously provide in its interior compartments 14 that are standardized or individually assembled by means of the inner frame rack 6 and serve for accommodating equipment to be integrated.

The equipment in question that, for example, serves for handling data-processing applications such as on-board entertainment (“in-flight entertainment”) or communications produces waste heat in a confined area and therefore has a relatively high cooling requirement in some instances. In order to meet this cooling requirement, the outer frame rack 4 features at least one cooling air inlet 12 that is arranged, for example, on the upper side of the frame rack 4 and through which cooling air made available, for example, by a central cooling system can be introduced, wherein said cooling air can be once again discharged from the equipment carrier 2 after cooling the equipment through a cooling air outlet that is not illustrated in FIG. 1. The cooling air may also be taken in/discharged through openings in the equipment carrier 2 that are arranged, e.g., on the front side or the underside of the equipment carrier.

In the illustration according to FIG. 1, the inner frame rack 6 accommodates, for example, several compartments 14 for inserting and mounting equipment therein. The compartments 14 preferably feature inserts (“trays”) for the equipment and the rear wall (“backplane”) of the inner frame rack 6 features all interfaces required for the wiring and for the supply of the equipment, particularly for the electrical supply and for the link to data networks or data buses. The illustration according to FIG. 1 shows a shelf system of sorts, in which flat or frame-shaped elements 10, for example, are used in order to form compartments a variable size. On the other hand, it would also be possible to utilize linear or punctiform elements suitable for mounting equipment. In addition to the aforementioned means, it would also be conceivable to use any other suitable type of compartmentalizing means or compartment shapes. In this case, compartmentalizing means 10 may be held on the inner rack 6 with latching means, mechanical connecting points or guides, wherein the latching means, connecting points or guides may be provided on an outer frame of the inner rack 6.

If so required, an equipment carrier 12 according to the invention can be expanded with different expansion modules 16. For example, the width of an equipment carrier 2 according to the invention with its special shape that is adapted to the cargo area of an aircraft can be expanded by means of a simple cuboid expansion module 16. The expansion module 16 also features an outer frame rack 18 with at least one cooling air inlet 20 on one side. An expansion module 16 may also be provided with a cooling air inlet at a different location, e.g., on the front side or the underside. An inner frame rack 22 is situated within the outer frame rack 18 and divided in the same fashion as the inner frame rack 6 of the original unexpanded equipment carrier 2 in the example shown.

The equipment carrier 2 according to the invention could be integrated, for example, into a vehicle structure—in this case the aircraft structure—in the cargo area as illustrated in FIG. 1. In order to realize this integration, for example, a support 24 could be arranged on the floor 26 of the cargo area and the equipment carrier 2 according to the invention could be screwed or otherwise fixed to this support.

The cooling air inlets 12 and 20 that receive air—as illustrated in an exemplary fashion—from cooling air outlets 28 and 30 are arranged on a cooling air duct 32 in the installed and fitted state of the equipment carrier 2. The cooling air outlets that are not illustrated in FIG. 1 are connected to exhaust air openings 34 and 36 of an exhaust air duct that transport the heated cooling air away from the equipment carrier 2. FIG. 1 also shows a completely assembled equipment carrier 2 according to the invention that is connected to cooling air outlets 28 and 30 and mounted on a support 24 on the floor 26 of the cargo area. Different pieces of equipment 40 are integrated into the equipment carrier 2 according to the invention, wherein the dimensions of the compartments 14 are adapted to said equipment such that the structural space made available within the equipment carrier virtually is optimally utilized. With the exception of the special geometric points with slanted side walls, hardly any unused gaps remain within the equipment carrier 2.

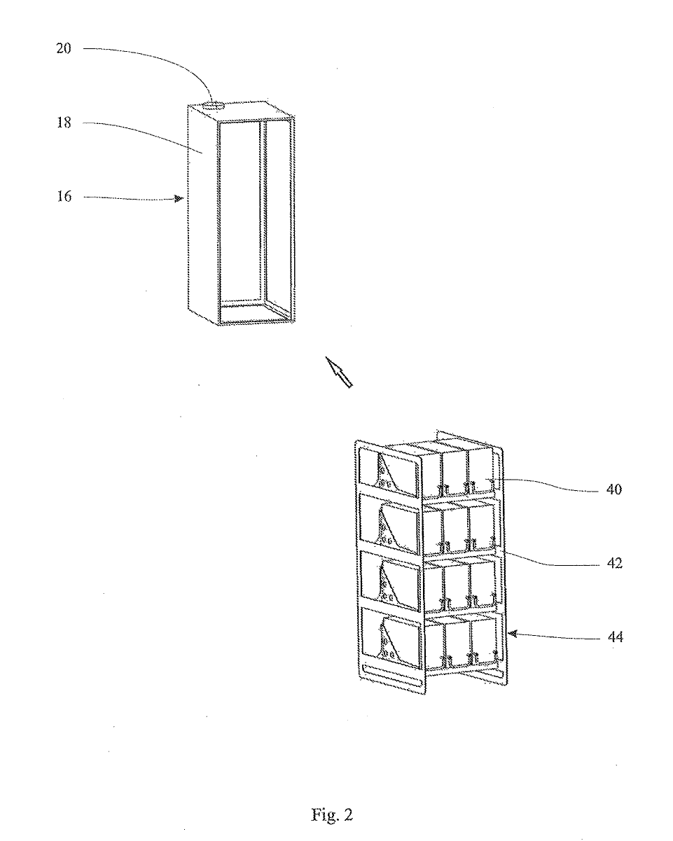

FIG. 2 shows an exemplary embodiment of the equipment carrier 2 according to the invention in the form of the simplest geometric illustration of an expansion module 16. The expansion module 16 features the outer frame rack 18 that essentially has a cuboid shape and, analogous to the outer frame rack 4, may consist of a material with a honeycomb core that has a relatively low specific weight, but a high strength. The cooling air inlet 20 is located on the upper side. An inner frame rack 42 can be integrated into this outer frame rack 18, wherein the inner frame rack features, for example, 4 rows of shelves 44, into which three pieces of equipment 40 can be respectively integrated. The inner frame rack 42 represents an individual equipment carrier that may also be referred to as a “subrack.” This individual equipment carrier 42 can be individually fitted for the operator of the respective vehicle or aircraft and inserted into the outer frame rack 18 with standardized dimensions. Consequently, the available structural space can be individually adapted to the number of required pieces of equipment 40 by providing different expansion modules in the form of outer frame racks 18 that can be attached to other, adjacent outer frame racks 4.

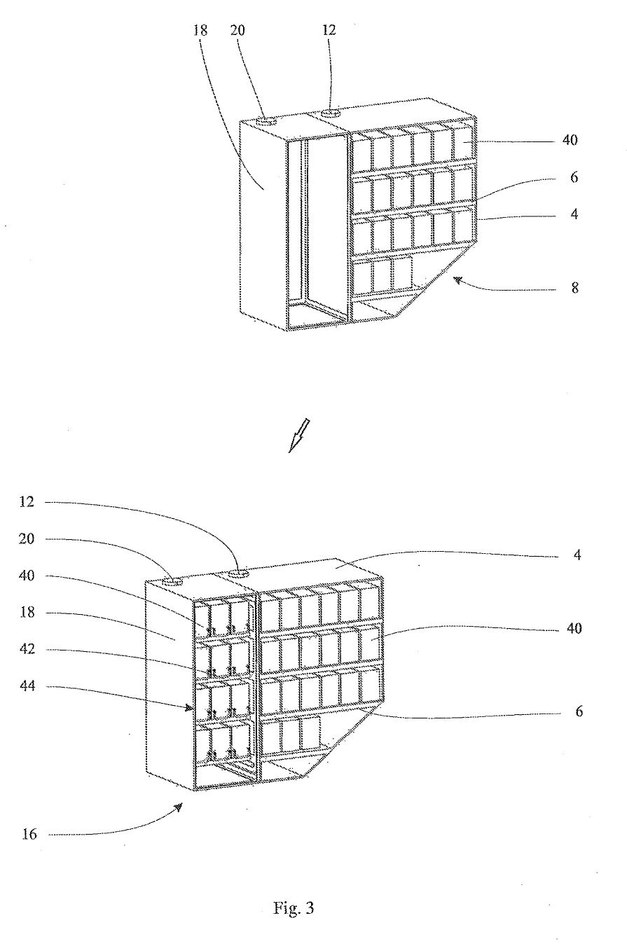

This process is schematically illustrated in FIG. 3, in which a combination of an outer frame rack 4 and an inner frame rack 6 with several pieces of equipment 40 arranged therein is already installed into the available structural space of the aircraft in the form of a base module. If more equipment 40 than originally planned is required on board of the aircraft, another outer frame rack 18 can be easily attached to the originally installed outer frame rack 4 in order to thusly expand the standardized structural space for accommodating an individual equipment carrier in the form of an inner frame rack 42. An empty expansion module 16 is illustrated on the upper left side in FIG. 3, wherein said expansion module is fitted with an individual equipment carrier 42 on the lower right side in FIG. 3. In this case, the individual adaptations would be limited to connecting the supply and discharge ducts for cooling air, of which only the cooling air supply openings 12 and 20 are visible, to cooling air ducts. It is also necessary to fit the expansion modules 16 with the required electrical wiring. However, since electrical wiring and ducts can be realized much more flexibly than the creation of individual structural spaces that need to meet significant mechanical requirements, these individual adaptations are not associated with a high expenditure of labor or complicated design work.

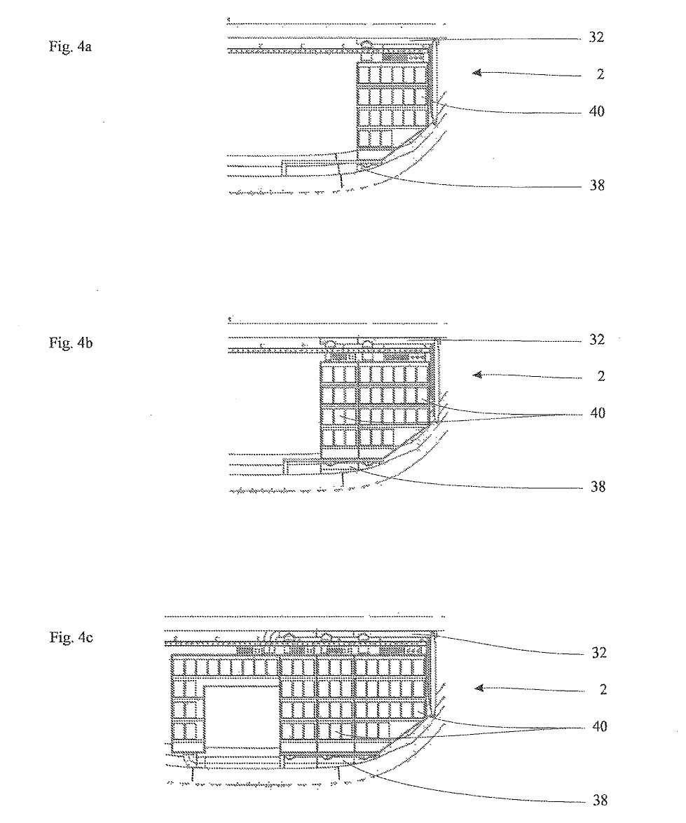

Possible variations of the equipment carrier according to the invention are illustrated in FIGS. 4a to 4c, in which the number of pieces of equipment 40 arranged within the equipment carrier 2 varies. For example, FIG. 4a shows the basic design with only a base module consisting of an outer frame rack 4 and an inner frame rack 6 that is adapted to the side of the cargo area of the aircraft. In FIG. 4b, an expansion module 16 is used for expanding the equipment carrier 2 according to the invention such that the number of pieces of equipment 40 that can be accommodated therein is already relatively large. For this purpose, the cooling air duct 32, as well as the exhaust air duct 38, is extended accordingly. FIG. 4c shows an extreme example, in which practically the majority of the available width of the cargo area is taken up by various expansion modules 16. This figure shows that it is not absolutely imperative that the expansion modules 16 have a cuboid shape that extends over the entire height of the base module, but rather may extend, for example, over only part of this height such that a passage or a recess can be created according to the illustration in FIG. 4c.

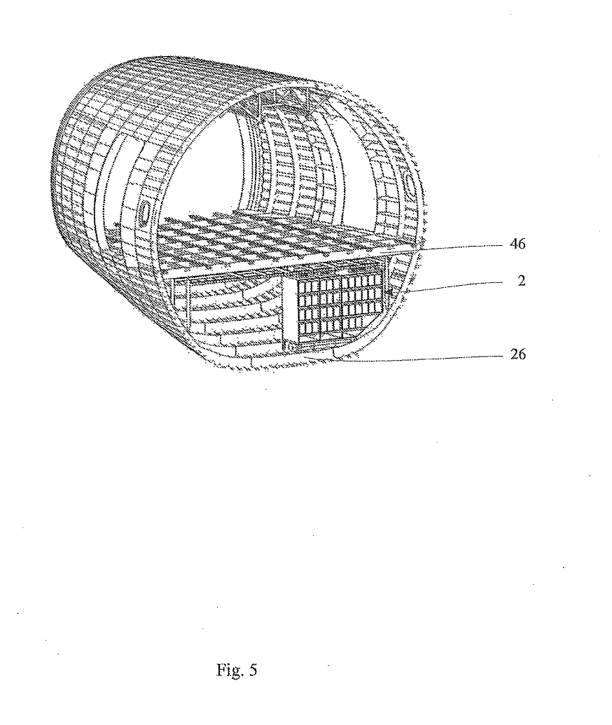

In addition, one preferred embodiment for accommodating an equipment carrier according to the invention in a cargo area of an aircraft is graphically illustrated in FIG. 5, wherein the equipment carrier 2 essentially extends from a cargo area floor 26 up to a cabin floor 46.

The equipment carrier 2 according to the invention advantageously makes it possible, in particular, to individually meet the requirements of the vehicle operator with respect to the integration of (electronic) equipment. Each vehicle operator has certain preferences with respect to the selection of equipment and therefore its dimensions and energy consumption such that an individual solution for accommodating this equipment needs to be found for each vehicle operator in the state of the art. The solution according to the invention makes it possible to meet individual requirements without having to forgo a modular design with standardized assemblies. The modular design eliminates extensive adaptations, significantly lowers the expenditure of labor and makes it possible to realize an adaptation to equipment to be exchanged, supplemented or removed without significant expenditures. The equipment carrier according to the invention can also be used for safety-critical avionics equipment that is required for the function of the aircraft and essentially not chosen by the aircraft operators.

As a supplement, it should be noted that “comprising” does not exclude other elements or steps, and that “an” or “a” does not exclude a plurality. It should furthermore be noted that characteristics or steps that were described with reference to one of the above exemplary embodiments can also be used in combination with other characteristics or steps of other above-described exemplary embodiments. Reference symbols in the claims should not be interpreted in a restrictive sense.

### LIST OF REFERENCE SYMBOLS

2 Equipment carrier
4 Outer frame rack
6 Inner frame rack
8 Beveled corner of outer frame rack
10 Compartmentalizing means
12 Cooling air inlet
14 Compartment for one piece of equipment
16 Expansion module
18 Outer frame rack of expansion module
20 Cooling air inlet of expansion module
22 Inner frame rack of expansion module
24 Support for fixing equipment carrier on cargo area floor
26 Cargo area floor
28 Cooling air outlet of cooling air duct
30 Cooling air outlet of cooling air duct
32 Cooling air duct
34 Exhaust air inlet opening of exhaust air duct
36 Exhaust air inlet opening of exhaust air duct
38 Exhaust air duct
40 Piece of equipment
42 Inner frame rack
44 Row of shelves
46 Cabin floor

1. An equipment carrier for mounting equipment in a vehicle, comprising at least one first outer rack and at least one inner rack,
wherein the first outer rack is supportable on the structure of the vehicle, connectable to one or more second outer racks in a modular design and provides a storage compartment designed for mounting the at least one inner rack therein, and wherein the at least one inner rack comprises at least one of a latching means, mechanical connection points or guides for variably mounting compartmentalizing means for creating at least one compartment for inserting and mounting at least one tray for receiving at least one piece of equipment each,
wherein the at least one first outer rack comprises at least one interface for supplying the piece of equipment.

2. The equipment carrier according to claim 1, wherein the interface is a cooling connection.

3. The equipment carrier according to claim 1, wherein the interface is an electrical interface.

4. The equipment carrier of claim 1, wherein the at least one inner rack or the outer rack is frame rack.

5. (canceled)

6. The equipment carrier of claim 1, wherein the at least one first outer rack is partly or entirely made of a material with a honeycomb core.

7. The equipment carrier of claim 1, wherein the at least one first outer rack is designed for completely supporting loads of the vehicle and the rack that act upon the at least one first outer rack.

8. The equipment carrier of claim 1, wherein the at least one inner rack is insertable into the corresponding first outer rack.

9. (canceled)

10. (canceled)

11. The equipment carrier of claim 1, wherein the at least one inner rack is partly or entirely made of a metallic material.

12. (canceled)

13. (canceled)

14. An aircraft with an equipment carrier of claim 1.

15. The aircraft of claim 14, wherein the equipment carrier is located within a cargo area.
